(19) United States
(12) Patent Application Publication
(10) Pub. No.: US 2025/0299224 A1
(43) Pub. Date: Sep. 25, 2025

(54) SERVER AND TERMINAL FOR VEHICLE FOR RECOMMENDING POINT OF INTEREST RELATING TO DESTINATION BASED ON CARD PAYMENT HISTORY

(71) Applicants: Hyundai Motor Company, Seoul (KR); Kia Corporation, Seoul (KR)

(72) Inventor: Chi Hwan Kim, Seoul (KR)

(21) Appl. No.: 18/932,317

(22) Filed: Oct. 30, 2024

(30) Foreign Application Priority Data
Mar. 21, 2024 (KR) 10-2024-0039239

(51) Int. Cl. G06Q 30/0251

(52) U.S. Cl. CPC G06Q 30/0261; G06Q 30/0255

(57) ABSTRACT

A server for recommending points-of-interest (POIs) relating to a destination based on a card payment history, includes at least one processor; and a storage medium storing a computer-readable instruction, where the computer-readable instruction, when executed by the at least one processor, is configured to receive a recommendation request including the destination; extract, after receiving the recommendation request, the POIs relating to the destination, based on the card payment history at the POIs, where the card payment history includes at least one of: a payment date and time, a business name, and address information of at least one of the POIs; and transmit the extracted POIs relating to the destination.

### CROSS-REFERENCE TO RELATED APPLICATION(S)

This application claims under 35 U.S.C. § 119 (a) the benefit of Korean Patent Application No. 10-2024-0039239 filed on Mar. 21, 2024 in the Korean Intellectual Property Office, the entire contents of which are incorporated herein by reference

### BACKGROUND

### (a) Technical Field

The present disclosure relates to a server and a terminal for a vehicle for recommending a point-of-interest (POI) relating to a destination, which may be based on a card payment history at the POI.

### (b) Description of the Related Art

A navigation terminal may be a device using a GPS satellite to generate address information and displaying the address information on a driving route to a destination. In such a navigation terminal, when a driver enters a destination, a server may search for and provide a route to the destination, or may recommend a location near the destination.

However, the recommended location may be often located several kilometers or more from the destination, and thus may not satisfy needs of the driver who may not want to walk to the destination.

In addition, when the a visit to a nearby location after parking a vehicle, such as a public parking lot or the like, is desired at the destination, or when a necessary item should be bought at a nearby convenience store or the like during washing of a vehicle, such as at a car wash or the like, at a destination, it may be a burden to search again for a location within walking distance.

Additionally, the number of payments and the number of set destinations may be generally proportional. However, as illustrated in Table 1 below, although affiliated stores B to C may be popular due to a large number of payments, actual frequency of set destinations may be significantly low due to low awareness of a user.

TABLE 1

| Affiliated Store | Number of Payments | Number of set Destinations |
|---|---|---|
| A | 5559 | 1616 |
| B | 1793 | 34 |
| C | 1740 | 236 |
| D | 2004 | 0 |

### SUMMARY

According to an embodiment of the present disclosure, a server and a terminal for recommending a point-of-interest (POI) relating to a destination based on card payment history, may recommend a well-known affiliated store not recognized by a user, while reducing inconvenience of having to search for a nearby affiliated store, after arriving at the destination.

According to an aspect of the present disclosure, a server for recommending points-of-interest (POIs) relating to a destination based on a card payment history, includes at least one processor; and a storage medium storing a computer-readable instruction, wherein the computer-readable instruction, when executed by the at least one processor, is configured to receive a recommendation request including the destination; extract, after receiving the recommendation request, the POIs relating to the destination, based on the card payment history at the POIs, wherein the card payment history includes at least one of: a payment date and time, a business name, or address information of at least one of the POIs; and transmit the extracted POIs relating to the destination.

According to an embodiment of the present disclosure, the destination may be a location in which a user temporarily parks a target vehicle to visit at least one of the POIs relating to the destination, not a dedicated parking location for a POI, and the POIs relating to the destination may be card-affiliated stores located proximate (e.g., within walking distance, for the user, from) the destination.

According to an embodiment of the present disclosure, the destination may include any one of a public parking lot, a building parking lot, a car wash, a vehicle repair shop, or a charging station.

According to an embodiment of the present disclosure, walking distance or “proximate” may be within a few hundred meters.

According to an embodiment of the present disclosure, at least one of the POIs relating to the destination may include a POI not registered in the server.

According to an embodiment of the present disclosure, the at least one processor may be configured to, based on card payment history, group the POIs relating to the destination; and extract the grouped POIs as POIs relating to the destination.

According to an embodiment of the present disclosure, the grouped POIs may be card-affiliated stores having card payment history in which payment is made, for vehicles and a user of each of the vehicles stayed at the destination during a preset period of time from a point in time at which a target vehicle arrives at the destination, by the user of each of the vehicles during a period of time for which the vehicles remain at the destination.

According to an embodiment of the present disclosure, the at least one processor may be configured to group the POIs, based on at least one of address information of a POI, a name of the destination, or a pivot POI.

According to an embodiment of the present disclosure, the at least one processor may be configured to perform at least one of, based on the address information of the POI, grouping POIs located in a predetermined region in which the number of the POIs is equal to or greater than a preset number; based on the name of the destination, grouping POIs including the name of the destination; or grouping a pivot POI and POIs relating to the pivot POI.

According to an embodiment of the present disclosure, the pivot POI may be a POI in which the number of card payments falls within a preset ranking, among POIs located proximate (e.g., within walking distance from) the destination, and POIs relating to the pivot POI may be POIs in which the number of card payments made by the same user, after card payment at the pivot POI, falls within a preset ranking.

According to an embodiment of the present disclosure, the at least one processor may be configured to determine whether the destination is a POI recommendation target, and as a result of the determination, when the destination is the POI recommendation target, transmit the POIs relating to the destination.

According to an embodiment of the present disclosure, the at least one processor may be configured to determine whether the destination is a POI recommendation target, based on at least one of an type of business of the destination, an average time of remaining at the destination, a POI density around the destination, an average search number for a nearby POI while staying at the destination, or the number of reviews about the destination, wherein the average time and the average search number may be based on at least one of vehicles or a user of each of the vehicles stayed at the destination during a preset period of time from a point in time at which a target vehicle arrives at the destination.

According to an embodiment of the present disclosure, the at least one processor may be configured to perform at least one of, when the type of business of the destination is any one of a parking lot, a car wash, a vehicle repair shop, a charging station or the like, determining the destination as the POI recommendation target; when the average time is equal to or greater than a preset time, determining the destination as the POI recommendation target; when a preset number or more of POIs are located within a preset radius according to a POI density around the destination, determining the destination as the POI recommendation target; when the average search number is equal to or greater than a preset number, determining the destination as the POI recommendation target; and when the number of reviews is equal to or greater than a preset number, determining the destination as the POI recommendation target.

According to an embodiment of the present disclosure, the at least one processor may be configured to determine, when there are two or more searched destinations, among the searched destinations, a destination in which a POI fitting the taste of a user is present, as the POI recommendation target.

According to an embodiment of the present disclosure, the at least one processor may be configured to sort and transmit the POIs relating to the destination in a ranking by a type of business according to at least one of the number of reviews, evaluation scores, or the number of card payments during a predetermined period.

According to an embodiment of the present disclosure, the at least one processor may be configured to transmit POIs of a preset type of business in response to an average time of remaining at the destination.

According to an aspect of the present disclosure, a terminal for recommending points-of-interest (POIs) relating to a destination based on a card payment history, includes at least one processor; and a storage medium storing a computer-readable instruction, wherein the computer-readable instruction, when executed by the at least one processor, is configured to search for the destination, transmit a recommendation request including the searched destination, and in response to the recommendation request, receive and output the POIs relating to the destination, wherein the POIs relating to the destination may be extracted based on the card payment history at the POIs, and wherein the card payment history includes at least one of: a payment date and time, a business name, and address information of at least one of the POIs.

According to an embodiment of the present disclosure, the destination may be a location in which a user temporarily parks a target vehicle to visit at least one of the POIs relating to the destination, not a dedicated parking location for a POI, and the POIs relating to the destination may be card-affiliated stores located proximate (e.g., within walking distance, for the user, from) the destination.

According to an embodiment of the present disclosure, the destination may include any one of a public parking lot, a building parking lot, a car wash, a vehicle repair shop, or a charging station, and proximate (e.g., walking distance) may be within a few hundred meters.

According to an embodiment of the present disclosure, the at least one processor may be configured to output the POIs relating to the destination at at least one point in time of a point in time at which the POIs relating to the destination are received, or a point in time at which route guidance to the destination ends.

A vehicle may include the above-described terminal.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating an entire system including a server and a terminal for recommending a POI related to a destination based on card payment history according to an embodiment of the present disclosure.

FIGS. 2A to 2C are views illustrating a process of grouping POIs based on at least one of address information of a POI, a name of a destination, or a pivot POI, according to an embodiment of the present disclosure.

FIG. 3 is a flowchart illustrating a method for recommending a POI related to a destination based on card payment history according to an embodiment of the present disclosure.

FIG. 4 is a flowchart specifying S313 of FIG. 3.

FIG. 5 is a block diagram of a computing device that may fully or partially implement a server and a terminal for recommending a POI relating to a destination based on card payment history according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-

transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, specific embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the embodiments of the present disclosure, when it is determined that a detailed description of a known technology related to the present disclosure may unnecessarily obscure the gist of the present disclosure, a detailed description thereof will be omitted. In addition, terms to be described later are terms defined in consideration of functions in the present disclosure, which may be changed depending on intention or custom of a user or operator. Therefore, the definition of these terms should be made based on the contents throughout the present specification. The terminology used herein is for the purpose of describing particular embodiments only and is not to be limiting of the embodiments. As used herein, the singular forms are intended to include the plural forms as well, unless the context clearly indicates otherwise.

Hereinafter, an embodiment of the present disclosure will be described in detail with reference to the drawings.

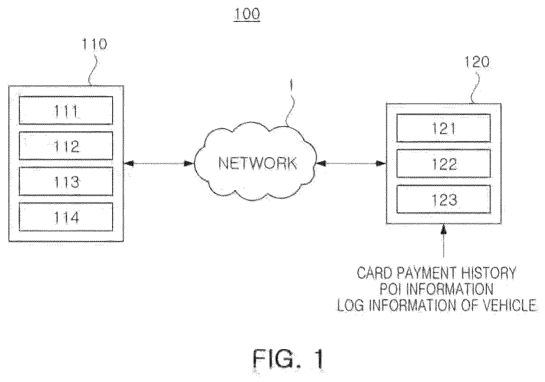

FIG. 1 is a view illustrating an entire system including a server and a terminal for recommending a POI related to a destination based on card payment history according to an embodiment of the present disclosure. An entire system 100 may include a terminal 110 and a server 120, connected to a network 1.

The terminal 110 and the server 120, described above, may include a processor (e.g., a computer, a microprocessor, a CPU, an ASIC, a logic circuit, or the like), and a memory storing software instructions that provide functions described above when executed by the processor. In this case, the processor and the memory may be implemented as separate semiconductor circuits. Alternatively, the processor and the memory may be implemented as a single integrated semiconductor circuit. The processor may be provided as at least one processor.

Referring to FIG. 1, the server 120 may extract points-of-interest (POIs) relating to a destination, and may transmit the POIs relating to the destination to the terminal 110 according to a recommendation request from the terminal 110. This server 120 may include a control unit 121, a storage unit 122, and a communication unit 123, and may also be referred to as a route search server or a navigation server.

Specifically, when the recommendation request is received from the terminal 110, the control unit 121 may extract the POIs relating to the destination based on card payment history at the POIs. In this case, the card payment history may include payment date and time, a business name of a POI, address information of the POI, or the like, and may be provided from a card company server (not illustrated).

The above-mentioned destination refers to a location in which a user temporarily parks a target vehicle to visit at least one of the POIs relating to the destination, and may not be a dedicated parking location for a POI. These destinations may include any of a public parking lot, a building parking lot such as hotels, a car wash, a vehicle repair shop, a charging station, or the like.

Additionally, the POIs relating to the destination, described above, may refer to card-affiliated stores located proximate (e.g., within walking distance, for the user, from) the destination. Walking distance may be within a few hundred meters.

Additionally, the POIs relating to the destination, described above, may include affiliated stores that may be not registered in the server 120. Typically, a manager of the server 120 may receive affiliated store information from the card company server (not illustrated), and may register the same in the server 120. Registering with the card company server for card payment and registering with the server 120 for route search may be separate procedures, and purposes thereof may be to register only with the card company server and extract affiliated stores that have not yet been registered with the server 120.

Specifically, the control unit 121 may group the POIs relating to the destination, based on card payment history, and may extract the grouped POIs as the POIs relating to the destination.

In this case, the grouped POIs may refer to card-affiliated stores having card payment history in which payment is made, for vehicles and a user of each of the vehicles stayed at the destination during a preset period of time (e.g., one month) in the past from a point in time at which a target vehicle arrives at the destination, by the user of each of the vehicles during a period of time for which the vehicles remain at the destination.

In this case, the period of time for which the vehicles remain at the destination may be obtained from vehicle log information provided from a plurality of vehicles. For example, the period of time for which the vehicles remain at the destination may be obtained by subtracting a point in time of departure from the destination from a point in time of arrival at the destination, or by subtracting the point in time of arrival at the destination from a point in time at which the vehicle turns on, to leave the destination. Alternatively, when it needs to pay a parking fee when removing the vehicle from the destination, the period of time for which the vehicles remain at the destination may be obtained in various ways, such as subtracting the point in time of arrival at the destination from a point in time of payment of the parking fee.

Specifically, the control unit 121 may group the POIs, based on at least one of address information of a POI, a name of the destination, or a pivot POI, and may extract the grouped POIs as the POIs relating to the destination. The address information of the POI, described above, may be obtained from POI information received from a POI management server (not illustrated), and the POI information may further include a type of business of a POI, the number of reviews, evaluation scores, or the like.

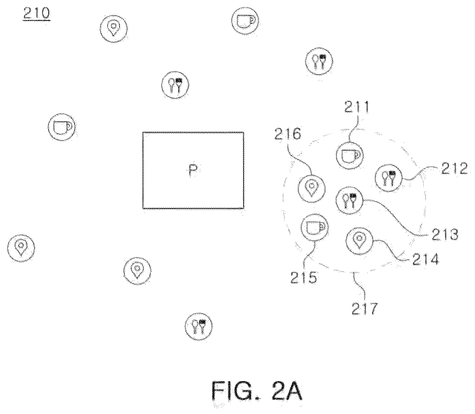

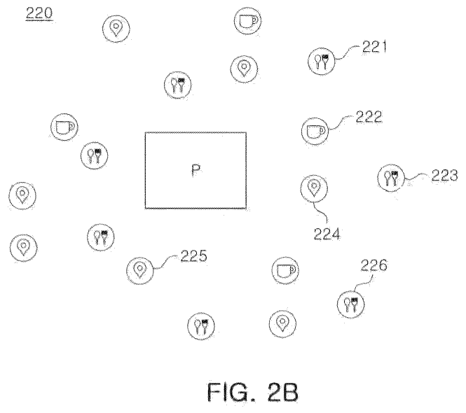

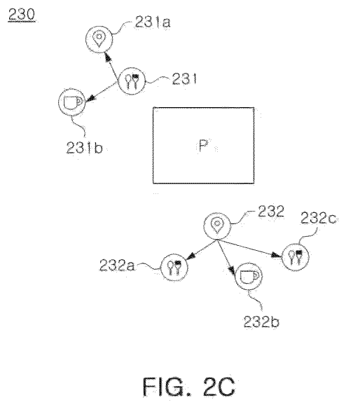

FIGS. 2A to 2C are views illustrating a process of grouping POIs based on at least one of address information of a POI, a name of a destination, or a pivot POI, according to an embodiment of the present disclosure.

First, FIG. 2A illustrates a grouping process 210 of POIs based on address information of the POIs. As illustrated in FIG. 2A, based on the address information of the POIs, a control unit 121 may group POIs 211 to 216 in which the number of the POIs located within a predetermined region 217 centered on a destination P is equal to or greater than a preset number. The POIs may be various card-affiliated stores, such as cafes, convenience stores, restaurants, or the like. For this purpose, an algorithm such as density-based spatial clustering of applications with noise (DBSCAN) may be used. The DBSCAN algorithm may be density-based clustering, a process in which, when a preset number (e.g. 6) or more of POIs is present within a certain radius around a certain point, the POIs are recognized as a single group.

FIG. 2B illustrates a grouping process 220 based on a name of a destination.

As illustrated in FIG. 2B, a control unit 121 may group POIs including a name of a destination based on the name of the destination.

For example, when a destination P is a parking lot of Sokcho Jungang Market in Korea, there may be POIs having various names around the destination P. According to an embodiment of the present disclosure, POIs 221 to 226 including a name of Sokcho Central Market, which may be the destination, may be grouped. Therefore, reference numerals 221 to 226 may be POIs including names using the name of Sokcho Jungang Market, such as Manseok Chicken Gangjeong_Sokcho Jungang Market Branch, Starbucks_Sokcho Jungang Market Branch, Coffee Bean_Sokcho Jungang Market Branch, GS Convenience Store_Sokcho Jungang Market Branch, or the like.

FIG. 2C illustrates a grouping process 230 based on a pivot POI.

As illustrated in FIG. 2C, a control unit 121 may group a pivot POI and POIs relating to the pivot POI.

In this case, pivot POIs 231 and 232 may refer to POIs in which the number of card payments falls within a preset ranking, among POIs located within walking distance from a destination P.

In addition, POIs 231a, 231b, 232a, 232b, and 232c, relating to the pivot POIs 231 and 232, may be POIs in which the number of card payments made by the same user, after card payment at the pivot POIs 231 and 232, falls within a preset ranking.

For example, this means that a user in which ate at a restaurant 231 may then visit a convenience store 231a or a cafe 231b.

Referring again to FIG. 1, the control unit 121 may further determine whether a destination is a POI recommendation target. As a result of the determination, when the destination is the POI recommendation target, the control unit 121 may transmit the POIs relating to the destination to the terminal 110.

According to an embodiment of the present disclosure, a control unit 121 may determine whether a destination is a POI recommendation target, based on at least one of an type of business of the destination, an average time of remaining at the destination, a POI density around the destination, an average search number for a nearby POI while staying at the destination, or the number of reviews about the destination. In this case, the average time and the average search number may be obtained for at least one of vehicles or a user of each of the vehicles stayed at the destination during a preset period of time (e.g., one month) in the past from a point in time at which a target vehicle arrives at the destination.

Specifically, the control unit 121 may determine the destination as the POI recommendation target, when the type of business of the destination is any one of a parking lot, a car wash, a vehicle repair shop, a charging station, or the like.

Alternatively, the control unit 121 may determine the destination as the POI recommendation target, when the average time of remaining at the destination, mentioned above, is equal to or greater than a preset time.

Alternatively, the control unit 121 may determine the destination as the POI recommendation target, when a preset number or more of POIs are located within a preset radius according to a POI density around the destination.

Alternatively, the control unit 121 may determine the destination as the POI recommendation target, when the average search number for nearby POIs while staying at the destination is equal to or greater than a preset number.

Alternatively, the control unit 121 may determine the destination as the POI recommendation target, when the number of reviews for the destination is equal to or greater than a preset number.

The determination of the POI recommendation target, described above, may be determined by either one alone or a combination thereof.

Additionally, when there are two or more destinations searched by the terminal 110, among the searched destinations, the control unit 121 may determine a destination in which a POI fitting taste of a user is present, as the POI recommendation target.

For example, when the destinations searched by the terminal 110 are 2 or more parking lots, and the taste of the user is to frequently go convenience stores, among the POIs around each of 2 or more parking lots, the parking lot with a convenience store nearby may be determined as the POI recommendation target. In the above example, the taste of the user is illustrated to prefer the convenience store, but this is merely illustrative to further understand the present disclosure, and of course, the taste of the user may be changed.

Additionally, when a recommendation request including a destination is received from the terminal 110, the control unit 121 may transmit the POIs relating to the destination, extracted above, to the terminal 110.

Alternatively, the control unit 121 may sort and transmit the POIs relating to the destination in a ranking by a type of business according to at least one of the number of reviews, evaluation scores, or the number of card payments during a predetermined period (e.g., one month).

Alternatively, the control unit 121 may transmit POIs of a preset type of business to the terminal 110 in response to an average time of remaining at the destination.

For example, when the average time of remaining at the destination is 30 minutes or less, POIs such as convenience stores or the like in which business is done within 30 minutes may be recommended.

For example, when the average time of remaining at the destination is 1 hour or less, POIs such as cafes or the like in which business is done within 1 hour may be recommended.

For example, when the average time of remaining at the destination is 2 hours or less, POIs such as restaurants or the like in which business is done within 2 hours may be recommended. The above-mentioned examples are illustrative to have further understanding, and of course, POIs corresponding to the average time of remaining at the destination may be changed depending on needs of those skilled in the art.

Alternatively, the control unit 121 may transmit the POIs relating to the destination, excluding POIs in which business is closed, based on a date of a week, and a point in time of arrival of the target vehicle at the destination, or may transmit the POIs relating to the destination, further including a business period of each of the POIs, to the terminal 110. In this manner, when recommending a POI, the date of the week and the business period may be used to prevent mistakenly visiting the POIs in which business is closed by the user.

The storage unit 122 may store various programs and data to implement functions performed by the control unit 121.

The communication unit 123 may be used to transmit and receive various data with the terminal 110 under control of the control unit 121.

The terminal 110 may search for a destination, and may transmit a recommendation request including the searched destination to the server 120, and may then receive and output POIs relating to the destination from the server 120.

The terminal 110 may be a device such as an infotainment system mounted on a vehicle or a smartphone having a navigation function. The above-mentioned infotainment system may be an integrated system of information, which refers to necessary information such as driving and route guidance, and entertainment, which refers to various entertainment and human-friendly functions, and may be a system that combines a vehicle navigation, an audio, a video, and the Internet.

This terminal 110 may be provided in a vehicle and may include a control unit 111, a storage unit 112, a communication unit 113, and an input/output unit 114.

Specifically, the input/output unit 114 may include an input device such as a pointing device (such as a mouse, a trackpad, or the like), a keyboard, a touch input device (such as a touchpad, a touch screen, or the like), a voice or sound input device, various types of sensor devices, and/or various types of imaging devices, and/or an output device such as a display device, a printer, a speaker, and/or a network card.

The control unit 111 may search for a destination through the input/output unit 114 described above, and may display a search route to the destination received from the server 120, and a current location of the vehicle on a map, or may transmit a recommendation request and a route search request, including a destination searched through the communication unit 113, to the server 120.

Additionally, the control unit 111 may output the POIs relating to the destination received from the server 120 through the input/output unit 114 described above.

Additionally, the control unit 111 may output the POIs relating to the destination at at least one point in time of a point in time at which the POIs relating to the destination are received, or a point in time at which route guidance to the destination ends.

The storage unit 112 may store various programs and data to implement functions performed by the control unit 111.

Lastly, the communication unit 113 may be used to transmit and receive various data with the server 120 under control of the control unit 111.

As described above, according to an embodiment of the present disclosure, POIs that may be reached on foot upon arrival at a destination may be recommended based on card payment history of a POI around the destination, to recommend a well-known affiliated store not recognized by a user, while reducing inconvenience of having to search for a nearby affiliated store, after arriving at the destination.

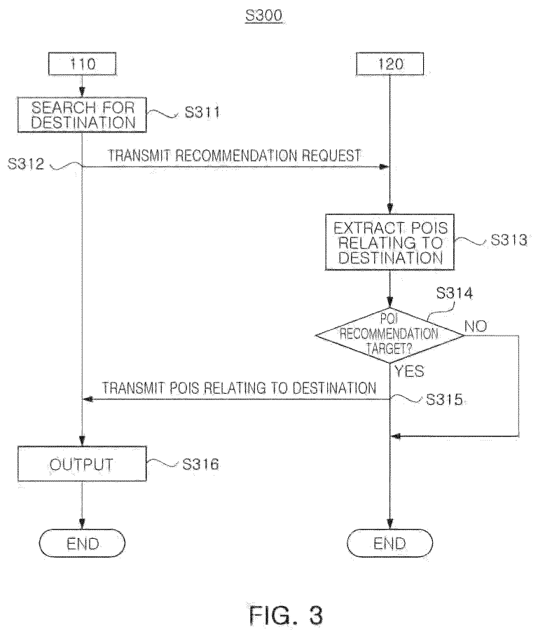

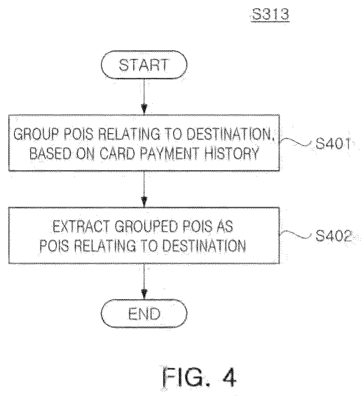

FIG. 3 is a flowchart illustrating a method for recommending a POI related to a destination based on card payment history according to an embodiment of the present disclosure. FIG. 4 is a flowchart specifying S313 of FIG. 3.

Hereinafter, with reference to FIGS. 1 to 4, a method (S300) for recommending a POI relating to a destination based on card payment history, according to an embodiment of the present disclosure, will be described. However, for simplification of the present disclosure, descriptions overlapping FIGS. 1 to 2C may be omitted.

Referring to FIGS. 1 to 4, a method (S300) for recommending a POI relating to a destination based on card payment history, according to an embodiment of the present disclosure, may be started by searching for the destination in a terminal 110 provided in a target vehicle, and transmitting a recommendation request including the searched destination to a server 120 (S311 and S312).

Thereafter, the server 120 may extract POIs relating to the destination according to the recommendation request (S313).

For example, when the server 120 receives the recommendation request from the terminal 110, the server 120 may extract the POIs relating to the destination based on card payment history at the POIs.

In this case, the above-mentioned destination refers to a location in which a user temporarily parks a target vehicle to visit at least one of the POIs relating to the destination, and may not be a dedicated parking location for a POI. These destinations may include any of a public parking lot, a building parking lot such as hotels, a car wash, a vehicle repair shop, a charging station, or the like.

Additionally, the POIs relating to the destination, described above, may refer to card-affiliated stores located within walking distance, for the user, from the destination. Walking distance may be within a few hundred meters.

Additionally, the POIs relating to the destination, described above, may include affiliated stores that may be not registered in the server 120.

Specifically, the server 120 may group the POIs relating to the destination, based on card payment history, and may extract the grouped POIs as the POIs relating to the destination.

In this case, the grouped POIs may refer to card-affiliated stores having card payment history in which payment is made, for vehicles and a user of each of the vehicles stayed at the destination during a preset period of time (e.g., one month) in the past from a point in time at which a target vehicle arrives at the destination, by the user of each of the vehicles during a period of time for which the vehicles remain at the destination.

Specifically, the server 120 may group the POIs, based on at least one of address information of a POI, a name of the destination, or a pivot POI, and may extract the grouped POIs as the POIs relating to the destination.

According to an embodiment of the present disclosure, the server 120 may perform at least one of, based on the address information of the POI, grouping POIs located in a predetermined region in which the number of the POIs is equal to or greater than a preset number; based on the name of the destination, grouping POIs including the name of the destination; or grouping a pivot POI and POIs relating to the pivot POI.

In this case, as described above, the pivot POI may be a POI in which the number of card payments falls within a preset ranking, among POIs located within walking distance from the destination, and POIs relating to the pivot POI may be POIs in which the number of card payments made by the same user, after card payment at the pivot POI, falls within a preset ranking.

According to an embodiment of the present disclosure, the server 120 may determine whether the destination is a POI recommendation target (S314), and as a result of the determination, when the destination is the POI recommendation target, may transmit the POIs relating to the destination (S314).

Specifically, the server 120 may determine whether a destination is a POI recommendation target, based on at least one of a type of business of the destination, an average time of remaining at the destination, a POI density around the destination, an average search number for a nearby POI while staying at the destination, or the number of reviews about the destination. In this case, as described above, the average time and the average search number may be obtained based on at least one of vehicles or a user of each of the vehicles stayed at the destination during a preset period of time (e.g., one month) in the past from a point in time at which a target vehicle arrives at the destination.

According to an embodiment of the present disclosure, the server 120 may perform at least one of, when the type of business of the destination is any one of a parking lot, a car wash, a vehicle repair shop, a charging station, or the like, determining the destination as the POI recommendation target; when the average time is equal to or greater than a preset time, determining the destination as the POI recommendation target; when a preset number or more of POIs are located within a preset radius according to a POI density around the destination, determining the destination as the POI recommendation target; when the average search number is equal to or greater than a preset number, determining the destination as the POI recommendation target; and when the number of reviews is equal to or greater than a preset number, determining the destination as the POI recommendation target.

According to an embodiment of the present disclosure, as described above, when there are two or more destinations searched by the terminal 110, among the searched destinations, the server 120 may determine a destination at which a POI fitting the taste of a user is present, as the POI recommendation target.

Afterwards, the server 120 may transmit the POIs relating to the destination, extracted above, to the terminal 110 (S315).

Alternatively, according to an embodiment of the present disclosure, the server 120 may sort and transmit the POIs relating to the destination in a ranking by a type of business according to at least one of the number of reviews, evaluation scores, or the number of card payments to the terminal 110 during a predetermined period.

Alternatively, according to an embodiment of the present disclosure, as described above, the server 120 may transmit POIs of a preset type of business to the terminal 110 in response to an average time of remaining at the destination.

Finally, the terminal 110 may receive and output the POIs relating to the destination from the server 120 (S316).

In this case, the terminal 110 may output the POIs relating to the destination at at least one point in time of a point in time at which the POIs relating to the destination are received, or a point in time at which route guidance to the destination ends (S316).

As described above, according to an embodiment of the present disclosure, POIs

that may be reached on foot upon arrival at a destination may be recommended based on card payment history of a POI around the destination, to recommend a well-known affiliated store not recognized by a user, while reducing inconvenience of having to search for a nearby affiliated store, after arriving at the destination.

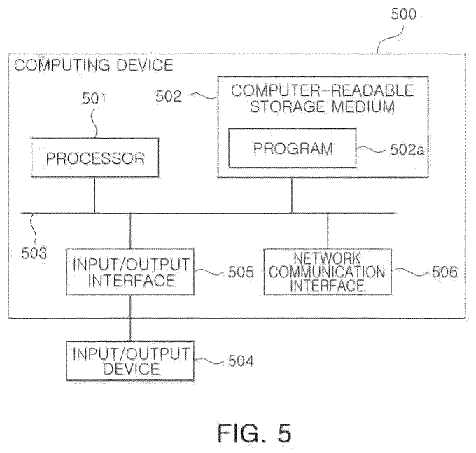

FIG. 5 is a block diagram of a computing device 500 that may fully or partially implement a server 120 and a terminal 110 for recommending a POI relating to a destination based on card payment history according to an embodiment of the present disclosure.

As illustrated in FIG. 5, a computing device 500 may include at least one processor 501, computer-readable storage medium 502, and communication bus 503.

The processor 501 may enable the computing device 500 to operate according to the above-mentioned embodiments. For example, the processor 501 may execute one or more programs stored in the computer-readable storage medium 502. The one or more programs may include one or more computer-executable instructions, which, when executed by the processor 501, cause the computing device 500 to perform operations according to embodiments.

The computer-readable storage medium 502 may be configured to store a computer-executable instruction or program code, program data, and/or information having other suitable form. A program 502a stored in the computer-readable storage medium 502 may include a set of instructions executable by the processor 501. In an embodiment, the computer-readable storage medium 502 may include a memory (a volatile memory, such as a random access memory, a non-volatile memory, or an appropriate combination thereof), at least one magnetic disk storage device, at least one optical disk storage device, at least one flash memory device, a storage medium accessible by the computing device 500 and storing desired information, or a suitable combination thereof.

The communication bus 503 may interconnect various other components of the computing device 500, including the processor 501 and the computer-readable storage medium 502.

The computing device 500 may also include at least one input/output interface 505 and at least one network communication interface 506, providing an interface for at least one input/output device 504. The input/output interface 505 and the network communication interface 506 may be connected to the communication bus 503. The network may be any one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 504 may be coupled to other components of the computing device 500 through the input/output interface 505. An example input/output device 504 may include, but is not limited to, an input device such as a pointing device (such as a mouse, a trackpad, or the like), a keyboard, a touch input device (such as a touchpad, a touch screen, or the like), a voice or sound input device, various types of sensor devices, and/or various types of imaging devices, and/or an output device such as a display device, a printer, a speaker, and/or a network card. The example input/output device 504 may be included in the computing device 500 as a component constituting the computing device 500, or may be connected to the computing device 500 as a separate device distinct from the computing device 500.

An embodiment of the present disclosure may include a program for performing methods described in the present specification on a computer, and a computer-readable recording medium containing the program. The computer-readable recording medium may include a program instruction, a local data file, a local data structure, or the like, singly or in combination. The medium may be those specifically designed and constructed for the present disclosure, or may be those commonly available in a computer software field. Examples of computer-readable recording medium may include a magnetic medium such as a hard disk, a floppy disk, or a magnetic tape, an optical recording medium such as a CD-ROM or a DVD, and a hardware device specifically configured to store and perform a program instruction such as a ROM, a RAM, a flash memory, or the like. Examples of the program may include not only a machine language code such as that generated by a compiler, but also a high-level language code that may be executed by a computer using an interpreter or the like.

According to an embodiment of the present disclosure, a point-of-interest (POI) that may be reached on foot upon arrival at a destination may be recommended based on card payment history of a POI around the destination, to recommend a well-known affiliated store not recognized by a user, while reducing inconvenience of having to search for a nearby affiliated store, after arriving at the destination.

While example embodiments have been illustrated and described above, it will be apparent to those skilled in the art that modifications and variations could be made without departing from the scope of the present disclosure as defined by the appended claims.

What is claimed is:

1. A server for recommending points-of-interest (POIs) relating to a destination based on a card payment history, comprising:
at least one processor; and
a storage medium storing a computer-readable instruction,
wherein the computer-readable instruction, when executed by the at least one processor, is configured to, by the at least one processor:
receive a recommendation request including the destination;
extract, after receiving the recommendation request, the POIs relating to the destination, based on the card payment history at the POIs, wherein the card payment history includes at least one of: a payment date and time, a business name, or address information of at least one of the POIs; and
transmit the extracted POIs relating to the destination.

2. The server of claim 1, wherein the destination is a location in which a user temporarily parks a target vehicle to visit the at least one of the POIs relating to the destination, and
the POIs relating to the destination are card-affiliated stores proximate the destination.

3. The server of claim 1, wherein the destination comprises any one of a public parking lot, a building parking lot, a car wash, a vehicle repair shop, a charging station, or the like.

4. The server of claim 1, wherein an additional one of the POIs relating to the destination comprises a POI not registered in the server.

5. The server of claim 1, wherein the at least one processor is configured to:
based on the card payment history, group the POIs relating to the destination; and
extract the grouped POIs as the POIs relating to the destination.

6. The server of claim 5, wherein the grouped POIs are card-affiliated stores having the card payment history in which payment is made, for vehicles and a user of each of the vehicles stayed at the destination during a preset period of time from a point in time at which a target vehicle arrives at the destination, by the user of each of the vehicles during a period of time for which the vehicles remain at the destination.

7. The server of claim 5, wherein the at least one processor is configured to group the POIs, based on at least one of address information of a POI, a name of the destination, and a pivot POI.

8. The server of claim 7, wherein the at least one processor is configured to perform at least one of:
based on the address information of the POI, grouping POIs located in a predetermined region in which the number of the POIs is equal to or greater than a preset number;
based on the name of the destination, grouping POIs including the name of the destination; or
grouping a pivot POI and POIs relating to the pivot POI.

9. The server of claim 8, wherein the pivot POI is a POI in which the number of card payments falls within a preset ranking, among POIs located proximate the destination, and
POIs relating to the pivot POI are POIs in which the number of card payments made by the same user, after card payment at the pivot POI, falls within a preset ranking.

10. The server of claim 1, wherein the at least one processor is configured to:
determine whether the destination is a POI recommendation target, and
as a result of the determination, when the destination is the POI recommendation target, transmit the POIs relating to the destination.

11. The server of claim 10, wherein the at least one processor is configured to determine whether the destination is a POI recommendation target, based on at least one of an type of business of the destination, an average time of remaining at the destination, a POI density around the destination, an average search number for a nearby POI while staying at the destination, or the number of reviews about the destination,
wherein the average time and the average search number are based on at least one of vehicles or a user of each of the vehicles stayed at the destination during a preset period of time from a point in time at which a target vehicle arrives at the destination.

12. The server of claim 11, wherein the at least one processor is configured to perform at least one of:
when the type of business of the destination is any one of a parking lot, a car wash, a vehicle repair shop, a charging station, or the like, determining the destination as the POI recommendation target;
when the average time is equal to or greater than a preset time, determining the destination as the POI recommendation target;
when a preset number or more of POIs are located within a preset radius according to a POI density around the destination, determining the destination as the POI recommendation target;
when the average search number is equal to or greater than a preset number, determining the destination as the POI recommendation target; and
when the number of reviews is equal to or greater than a preset number, determining the destination as the POI recommendation target.

13. The server of claim 10, wherein the at least one processor is configured to determine, when there are two or more searched destinations, among the searched destinations, a destination in which a POI fitting taste of a user is present, as the POI recommendation target.

14. The server of claim 1, wherein the at least one processor is configured to sort and transmit the POIs relating to the destination in a ranking by a type of business according to at least one of the number of reviews, evaluation scores, or the number of card payments during a predetermined period.

15. The server of claim 1, wherein the at least one processor is configured to transmit POIs of a preset type of business in response to an average time of remaining at the destination.

16. A terminal for recommending points-of-interest (POIs) relating to a destination based on a card payment history, comprising:
at least one processor; and
a storage medium storing a computer-readable instruction,
wherein the computer-readable instruction, when the computer-readable instruction is executed by the at least one processor, is configured to, by the at least one processor:
search for the destination,
transmit a recommendation request including the searched destination, and
in response to the recommendation request, receive and output the POIs relating to the destination,
wherein the POIs relating to the destination are extracted based on the card payment history at the POIs, and
wherein the card payment history includes at least one of: a payment date and time, a business name, and address information of at least one of the POIs.

17. The terminal of claim 16, wherein the destination is a location in which a user temporarily parks a target vehicle to visit at least one of the POIs relating to the destination, not a dedicated parking location for a POI, and
the POIs relating to the destination are card-affiliated stores located proximate the destination.

18. The terminal of claim 17, wherein the destination comprises any one of a public parking lot, a building parking lot, a car wash, a vehicle repair shop, a charging station, or the like.

19. The terminal of claim 16, wherein the at least one processor is configured to output the POIs relating to the destination at at least one point in time of a point in time at which the POIs relating to the destination are received, or a point in time at which route guidance to the destination ends.

20. A vehicle comprising the terminal of claim 16.
